(19) United States
(12) Patent Application Publication
(10) Pub. No.: US 2015/0141884 A1
(43) Pub. Date: May 21, 2015

(54) DEVICE FOR MASSAGING AND THE APPLICATION OF A COSMETIC COMPOSITION

(71) Applicant: L'OREAL, Paris (FR)

(72) Inventors: Laure Thiebaut, Clichy (FR); Soraya Kadra, Asnieres Sur Seine (FR)

(21) Appl. No.: 14/413,690

(22) PCT Filed: Jul. 5, 2013
(86) PCT No.: PCT/EP2013/064276

§ 371 Date: Jan. 8, 2015

Related U.S. Application Data
(60) Provisional application No. 61/681,786, filed on Aug. 10, 2012.

(30) Foreign Application Priority Data
Jul. 9, 2012 (FR) 1256595

(51) Int. Cl. A61H 15/00

(52) U.S. Cl. CPC A61H 15/0092; A61H 2201/1671
USPC 601/112; 601/154

(57) ABSTRACT

The present invention relates to a device (1) for massaging and the application of a cosmetic composition, comprising: —an end-piece (5) comprising a base (6) and elements (4) upstanding from this base, said elements (4) defining at least one first area (1) of elements (4) having a first hardness and a second area (2) of elements (4) having a second hardness greater than the first hardness, —a body (3) configured to receive the end-piece (5), —a means for setting the end-piece (5) in motion relative to the body (3), in which the elements (4) are configured such that the first area (1) is at least partly included in the second area (2) at their zone of attachment with the base.

The subject of the present invention is a device for massaging and/or cleansing and/or applying a cosmetic composition, including a care composition, to a surface of the body.

According to the invention, “cosmetic device” is understood to mean a device for massaging and/or for cleansing and/or for applying a cosmetic composition.

In particular, this end-piece is particularly advantageous in the field of massaging certain zones of the body and of cleansing the skin, and in particular in deep cleansing for removing impurities from the pores of the skin. It may also be useful in applications for cleansing or for care of the body.

The expression “cosmetic product” is understood to mean a product as defined in Council Directive 93/35/EEC of 14 Jun. 1993.

The application of a cosmetic composition with the aid of an assembly comprising an aerosol container and a device to be mounted on the aerosol container, comprising a rotating massaging member driven by an electric motor, is known from EP 1 728 494.

The invention aims to provide novel ways of massaging and/or applying certain cosmetic active agents.

Document FR 2 918 545 discloses an assembly for dispensing and applying a cosmetic composition, comprising:
a receptacle containing a cosmetic composition,
an end-piece,
an application device comprising:
   a body configured to receive the receptacle and the end-piece,
   a means for rotating the end-piece relative to the body, and
   a duct for conveying the composition from the receptacle towards an application surface of the applicator.

According to the teaching in this document, the rotation can make it possible to carry out at least one of a massaging action, a skin exfoliation action, and a composition spreading action, which can generate new sensations on application and can improve the effect of one or more active agents of the cosmetic composition.

Also according to this document, it is provided for the end-piece to have massaging reliefs, for example spikes or balls. However, no advantage connected to a particular choice of the end-piece is demonstrated.

Within the scope of massaging the body or face, end-pieces that provide an improved sensation of well-being while improving blood circulation or lymphatic circulation, so as to produce a decongestant effect, for example in the region of the contour of the eyes, the oval of the face, or the legs, are desired.

Within the scope of cleansing or care of the face, massaging end-pieces which are soft but nevertheless effective for obtaining clean skin, without imperfections, having a uniform complexion and without redness, are desired. To this end, the objective of cleansing the face, in particular for greasy skin or skin prone to acne, is to avoid the proliferation of bacteria, such as P. acnes, in the pores of the skin. For what is known as normal to dry skin, the main objective of cleansing the face is to remove dead skin by movements carried out by the end-piece on the skin, resulting in mechanical desquamation of the corneocytes.

There also exists a need to provide low cost massaging end-pieces, in order that they can be attached to any device for packaging a cosmetic composition, in particular when these devices contain active agents for cleansing the face, active agents for care of the face, or anti-cellulite active agents.

There also exists a need for a massaging and/or cleansing end-piece, the operation of which enables different levels of cleansing of the skin.

There also exists a need for a massaging and/or cleansing end-piece suitable for the hollows and reliefs of a body in order to follow the shape of the knees, heels or elbows.

There also exists a need for a massaging and/or cleansing end-piece which follows the variations in reliefs on the surface of the face, in particular at the nose, the sides of the nose, the cheekbones or the chin.

There also exists a need for a massaging and/or cleansing end-piece which provides new types of sensoriality while correctly applying the cosmetic products or while deep cleansing, and which massages in order to boost blood circulation and lymphatic circulation.

The object of the invention is to solve all or some of the problems identified above by providing an applicator which rotates (clockwise and/or counterclockwise rotation), oscillates, carries out a percussive movement or vibrates, comprising upstanding elements having different hardnesses in the core of the applicator and at the periphery, such that the prominent areas of the face and of the body compress the flexible core by exerting pressure on the latter so that the peripheral elements can act on the skin.

The subject of the invention is a cosmetic device comprising:
an end-piece comprising a base and elements upstanding from this base, said elements defining at least one first area of elements having a first hardness and a second area of elements having a second hardness greater than the first hardness,
a body configured to receive the end-piece,
a means for setting the end-piece in motion relative to the body, in which
   the elements are configured such that the first area is at least partly included in the second area at their zone of attachment with the base.
   Advantageously, the upstanding elements do not belong to the chemical family of the polyamides. In particular, the upstanding elements are not made of Nylon 612®.
   More particularly, the upstanding elements are chosen from:

(i) Synthetic elements, in particular synthetic fibers, chosen from:
PVC
polypropylene
polyethylene
polyester
abrasive fibers

(ii) Metal elements, in particular metal fibers, chosen from:
bronze
brass
stainless steel
corrugated steel
straight steel
flat steel.

With the device according to the invention, it is now possible to exert different pressures on contiguous areas of the skin during the movement of the end-piece, in order to carry out a more tonic massage with greater impact. It becomes possible to alternate the application of different pressure levels so as to achieve improved relaxation.

The invention also relates to a cosmetic method comprising the use of the above device.

The invention also relates to a kit comprising an above device.

The invention also relates to an end-piece as defined above.

According to the invention, “the first area is at least partly included in the second area” is understood as meaning if the first area can be at least partly traced inside the second at the zone of attachment with the base, for example if the first area comprises tops located at the perimeter of the second.

By way of illustration, the first area may be a circle, a triangle or a polygon and these may be included in a circle forming the periphery of the second area, which defines an annulus, at the zone of attachment with the base.

According to the invention, “more than x % of the first area is included in the second area” if, at the zone of attachment with the support, more than x % of the periphery (or of the peripheral contour of the first area) can be contained in the second area.

Advantageously, more than 40% of the first area is included in the second area, and more advantageously more than 70%.

In a particularly preferred manner, the first area is totally included in the second area.

In order to determine the percentage to which the first area is included in the second, the tangent to each point on the periphery of the first area is drawn. If the normal to this tangent passes through the area 2, this point is considered to be included in the area 2. The percentage of inclusion is obtained by forming the ratio of the contour of the points of the area 1 included in the overall contour of the area 1.

Massaging and Application Devices

Advantageously, the means for setting in motion is chosen from a means for setting in rotation, in vibration, in oscillation or in percussion or a combination thereof.

More advantageously, the means for setting in motion is chosen from a means for setting in rotation or in vibration or a combination thereof, and even more advantageously, the means for setting in motion is a means for setting in rotation.

Setting in Rotation

When the end-piece is rotated by the driving means, the speed of rotation of the end-piece may be for example between 100 and 400 rpm, preferably between 200 and 300.

The end-piece may be rotated about a geometric rotation axis which is fixed relative to the body. As a variant, the end-piece may be rotated about a geometric rotation axis which is able to move relative to the body. If necessary, the movement of the end-piece may be an eccentric movement, and this can make it possible to spread the composition more regularly and with a less pronounced border between the treated region and the untreated region, this possibly being advantageous for a self-tanner for example.

The end-piece may be rotated about a geometric rotation axis which forms a zero angle or non-zero angle with the longitudinal axis of the sleeve of the device. A non-zero angle may improve ergonomics.

The end-piece may be mounted removably on the massaging and application device, and this can make it possible to separate the application device in order to clean it and/or to replace it with another end-piece selected depending on the treatment to be carried out.

Setting in Vibration

The vibrating source may comprise, for example, a motor driving a flyweight, an eccentric, an electromagnet or a piezoelectric or mechanical vibrator.

The contact between the vibrating source and the base may be intermittent or extended, depending, for example, on the amplitude, the frequency and the orientation of the vibrations.

The vibration frequency is, for example, greater than or equal to 20 Hz.

The vibrations may be oriented transversely to the longitudinal axis of the base or parallel thereto, or oriented in some other way.

Material Forming the Upstanding Elements

The upstanding element may comprise a cellular material which may be elastically deformable and/or compressible. This material may be a foam. The foam may be produced from a material selected from the following list: Polyurethane, polyether, polyester, polyvinyl chloride, polyethylene, EVA, latex, silicone, SIS, SEBS, silicone elastomer, latex elastomer, nitrile elastomer, butyl elastomer, Neoprene®, NBR, SBR, this list not being limiting.

The upstanding element may have a composite structure having a plurality of layers having different natures, for example a number of types of foam.

The upstanding element may have any shape. It may have a circular, oval or polygonal cross section, for example a triangular, square, hexagonal, etc. cross section.

The upstanding element may have abrasive properties. “Abrasive property” should be understood as meaning a surface which, when moved over the skin, removes at least some of the dead cells from the surface.

Such surfaces can be characterized by an abrasive power of between 0.01 and 0.03 g/cm²/min. The abrasive power corresponds to the quantity of plaster removed per minute, per square centimetre of an abrasive surface applied to a square of plaster having a thickness of 50 mm using a 135W Black and Decker CD 400 sander, the pressure exerted on the square of plaster resulting from the weight of the sander, only the movement of which in the plane of the abrasive surface is constrained.

Such upstanding elements are obtained either by taking a substantially rigid cellular material, or by incorporating hard grains into a flexible cellular material.

An example of an abrasive surface is a nonwoven exfoliating pad sold by 3M.

The foam may be a soft and flexible foam particularly suitable for spreading the product, sometimes also known as a sponge.

The upstanding element may be for example a hydrophilic crosslinked polyester foam, for example having a density equal to 32 kg/m³.

A sponge traditionally used for applying foundation, such as NBR, for example Yukilon® from Penthouse Group is also conceivable.

The upstanding element may be a thermocompressed foam. Thermocompression makes it possible to create reliefs on the surface of the foam and/or to complex it with an elastic fabric, thereby making it possible to have the flexibility of the foam but the feel of a textile more pleasant than that of plastic.

An example of a thermocompressed foam is a closed-cell foam made of polyolefin, for example thermocompressed polyethylene having a specific weight of 33 kg/m³, which is for example complexed with an elastic fabric such as for example Lycra®.

The upstanding element may be a file made of plastics material, metal or glass.

The upstanding element may be made of injection-molded flexible plastics material, for example of elastomer, and have massaging reliefs, for example spikes having pointed ends, rounded ends, a round, square, or triangular cross section, a length of between 1 mm and 40 mm for example, etc., or balls having a round or oval cross section and a height of between 1 mm and 20 mm for example, etc.

The upstanding element is made for example of thermoplastic material. “Thermoplastic material” is understood to mean any thermoplastic material, for example SEBS, a silicone, latex, a natural rubber, a material having improved slip, butyl, EPDM, a nitrile, a thermoplastic elastomer “TPE”, a polyester elastomer, a polyamide elastomer, a polyethylene elastomer or a vinyl elastomer, a polyolefin such as PE or PP, in particular low density PE, PVC, EVA, PS, SIS, PET, POM, PU, SAM, PA or PMMA. Such materials have rapid drying characteristics when they are wetted on the surface, on account in particular of suitable surface tension characteristics. It is possible in particular to use the materials known under the trade names Teflon®, Hytrel®, Cariflex®, Alixine®, Santoprene®, Pebax® and Pollobas®. The material used to produce the upstanding element may contain a softening agent and/or a bactericidal agent, such as silver ions, for example.

The upstanding element may be a brush made of synthetic or natural bristles, for example a bristled brush having tufts of strands of polyamide or PBT for example having a diameter of between 0.05 and 0.2 mm and more particularly made of Nylon® 6.12 having a diameter of 0.075 mm, which have been milled and ground in order to make them very soft in contact with the skin.

The upstanding element may have elements that are able to rotate, such as balls or rollers, which are smooth or have reliefs, and are rigid or flexible, in order to massage the skin.

Hardness of the Upstanding Elements

For the first area, this hardness is specifically adapted to bring about gentle sagging of the area of the face, without being too energetic.

In order to determine whether “the elements defining at least a first area of elements have a first hardness and a second area of elements having a second hardness greater than the first hardness”, the following test is carried out.

Atmospheric conditions of 1 bar at 25° C. are set up and a pressure of 0.085 bar is applied in an equivalent manner to all the free ends of the upstanding elements for a period of 5 seconds. Which of the first or second areas is more flexible is determined by measuring, for each upstanding element, the variation in height undergone by applying the pressure of 0.085 bar.

The average variation in height of the elements of each portion is then calculated.

If this average variation in height is greater than an absolute value for the second area, the second hardness is said to be less than the first. The elements of the second area are more flexible than those of the first.

If this average variation in height is less than an absolute value for the second area, the second hardness is said to be greater than the first. The elements of the second area are harder than those of the first.

For the second area, this hardness is specifically adapted to bring about a tonic and firming massage.

Profile of the Base

Advantageously, the upstanding elements are implanted on a flat base.

Advantageously, the longitudinal section of the base at the zone of attachment of the upstanding elements is circular, square, polygonal or triangular.

Advantageously, the longitudinal section of the base at the zone of attachment of the upstanding elements measures between 1 cm² and 100 cm², more advantageously between 5 cm² and 20 cm². This dimension is specifically suitable for the face. It helps in reaching more difficult areas such as the contour of the nose. A dimension of between 20 and 100 cm² is particularly suitable for the body and makes it possible to treat large areas such as the thighs, the stomach or the back while making it possible to access the knees, elbows and shoulders.

The invention also relates to an assembly comprising a cosmetic receptacle comprising a through-hole in which at least one base designed to be used in a device as defined above is removably housed.

The invention may be better understood on reading the following description of non-limiting implementation examples thereof, and with reference to the attached drawing, in which:

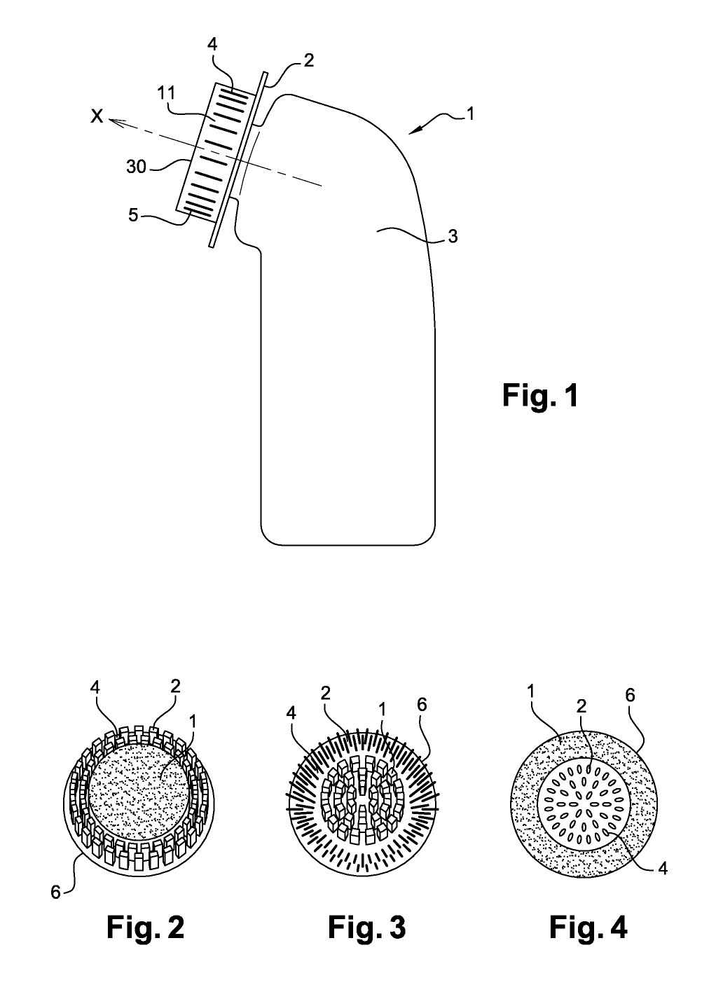

FIG. 1 schematically shows a front view of an example of a device according to the invention,

FIG. 2 is a top view of an end-piece according to the invention,

FIG. 3 is a top view of an end-piece according to the invention,

FIG. 4 is a schematic top view of an end-piece according to the prior art,

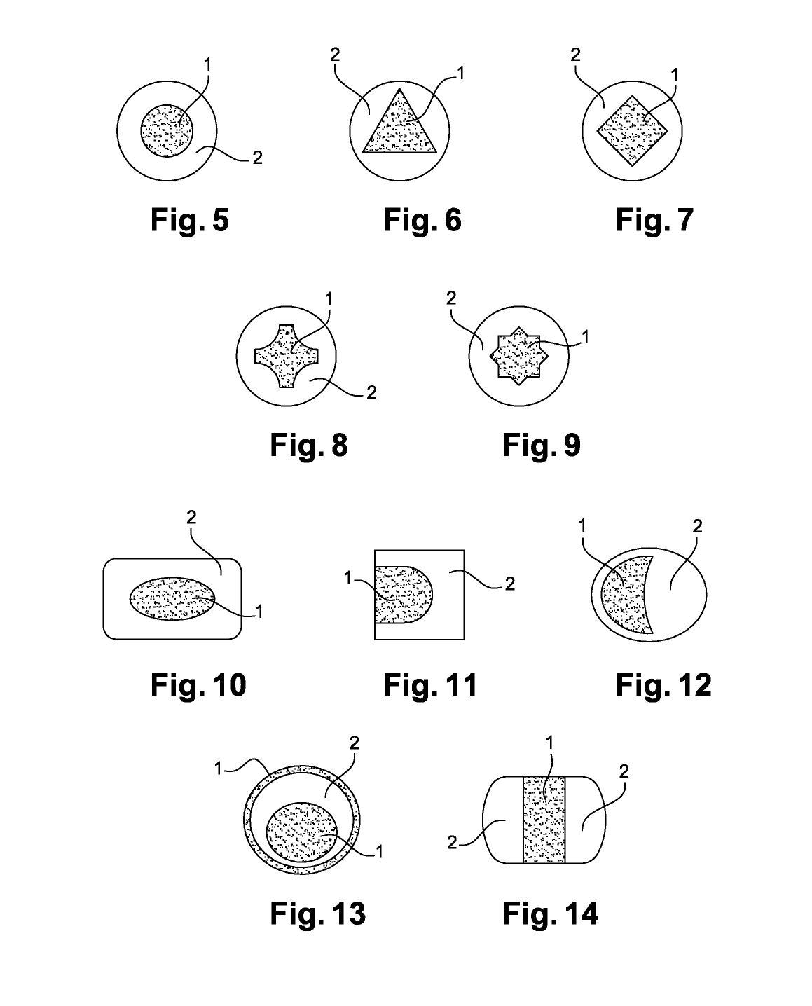

FIGS. 5 to 14 show longitudinal sections through the upstanding elements at their zone of attachment with the base.

FIG. 1 shows a device 1 produced in accordance with the invention.

This device 1 comprises a body 3 on which an end-piece 5 defining an application surface intended to come into contact with the skin may be fixed in a reversible manner.

The device 1 is for example produced in accordance with patent application US 2006/0276731.

The body 3 may house means for driving the end-piece 5 in a rotational movement relative to the body 3.

This movement is for example a rotational movement about a rotation axis X which is fixed relative to the body 3.

The driving means may comprise an electric motor which is housed in the body 3, is supplied by one or more rechargeable or non-rechargeable batteries, and rotates the end-piece about the axis X by way of gears.

In the example illustrated in FIG. 1, the end-piece 5 comprises upstanding elements 5 defining the application surface 30. The upstanding elements are fixed to a base 2 and are terminated by their free end 11.

In the example in FIG. 2, the end-piece is in accordance with the invention. It comprises a base 6 having a circular section at the zone of attachment with the upstanding elements 4. The upstanding elements 4 define two areas: a central area 1 in the form of a disk and a peripheral area 2 in the form of an annulus at the zone of attachment with the base.

The upstanding elements 4 in the central area 1 have a hardness less than those in the peripheral area 2. The central area 1 is entirely included in the peripheral area 2.

The central area 1 is formed by a soft and flexible, low-density foam. The peripheral area 2 comprises nylon bristles collected in tufts for example having a diameter of 0.075 mm. This assembly is particularly suitable for foaming the formulation while deep cleansing even concave areas.

The elements of which the area 1 is composed could also be selected from the following list:
Bristled fibers (nylon etc.),
Spikes made of flexible elastomer having various shapes: spikes having various shapes,
Balls, waves or various massaging shapes made of more flexible elastomer,
Sponge or some other flexible porous material.

The elements of which the area 2 is composed could also be selected from the following list:
Bristled fibers (nylon etc.) having a diameter of close to 0.1 mm,
Spikes made of elastomer having various shapes, Spikes having various shapes,
Balls, waves or various massaging shapes made of hard elastomer, Balls, waves or various massaging shapes made of rigid material (plastics material, glass, metal, ceramic etc.),
Sponge, foam or some other porous material.

When the included portion is chosen from the sponge, foam or porous material, a formulation retention zone that favors the spreading of the formulation on the skin during the movement of the end-piece is obtained. There will thus be a retention zone if the central part is concave or shorter.

In FIG. 3, the end-piece is in accordance with the invention. The central area 1 is formed by bristles. The area 2 is formed by spikes of elastomer. The spikes of the area 2 have a larger section than the bristles of the area 1 at their free ends. The spikes of the area 2 are harder than the bristles of the area 1. Stimulating cleansing is obtained with this assembly.

In FIG. 4, the end-piece is in accordance with the invention.

The upstanding elements 4 in the central area 2 have a hardness less than those in the peripheral area 1. The central area 2 is entirely included in the peripheral area 1.

The central area 2 is formed by tufts of nylon bristles. The peripheral area 1 comprises a very dense abrasive foam. This assembly will make it possible to obtain deep cleansing scrubbing.

The level of rigidity, the shape of the elements and the overall shape determine the application of these end-pieces and the intended cosmetic treatment. Abrasive and rigid assemblies are favorable for a vigorous massage and exfoliation. Flexible assemblies are favorable for a care application. Assemblies composed of bristles are favorable for cleansing.

Shapes with little protuberance and little relief provide greater softness. Strong protuberances and strong reliefs bring about a massage. Some shapes are favorable for acting on the texture of the formulation. Thus, sponges having large cells make it possible to foam, or, conversely, very dense sponges inhibit the foam, wipe or exfoliate.

FIGS. 5 to 14 show longitudinal sections through end-pieces at the zone of attachment of the elements with the base.

The area 1 composed of the elements having lower hardness is shown in a dark manner. The area 2 composed of the elements having greater hardness is shown in a light color.

In all of FIGS. 5 to 14, the area 2 at least partly surrounds the area 1. The end-pieces are in accordance with the invention.

In FIGS. 5 to 10 and 12 and 13, the area 2 totally surrounds the area 1. The periphery of the area 1 successively represents a circle, a triangle, a square, a star having 4 and 8 arms, an ellipse, a half moon or an ovoid. The external periphery of the area 2 forms a circle in FIGS. 1 to 9 and 13. In FIG. 12, the periphery is oval. It is polygonal in FIGS. 10, 11 and 14.

In FIGS. 11 and 14, the area 2 partly surrounds the area 1. The area 2 forms an open window in the area 1.

In order to use the device according to the invention, it is possible for example to apply a composition without the end-piece being rotated, and this can make it possible for example to spread the composition over the region to be treated. The end-piece is then rotated in order to massage the region to which the composition has been applied.

In another example, the end-piece is rotated in order to massage the region to be treated, without a composition being dispensed.

In yet another example, the end-piece is rotated in order to massage the region to be treated, without a composition being dispensed for a first time.

The massaging action may result in local heating on account of the friction of the end-piece on the skin for example, and the absence of the composition on the end-piece initially may increase the friction and the sensation of heat that results therefrom.

Next, while the end-piece is still being rotated or, as a variant, while the end-piece is at a standstill, the composition may be dispensed and spread over the region previously massaged.

In the entire description, the expression “comprising a” should be considered as being synonymous with “comprising at least one”, unless specified to the contrary.

1.-9. (canceled)

10. A cosmetic device, comprising:
an end-piece comprising a base and elements upstanding from the base, said elements defining at least one first area of elements having a first hardness and a second area of elements having a second hardness greater than the first hardness;
a body configured to receive the end-piece; and
a means for setting the end-piece in motion relative to the body,
wherein the elements are configured such that the first area is at least partly included in the second area at their zone of attachment with the base.

11. The device according to claim 10, wherein more than about 40% of the first area is included in the second area.

12. The device according to claim 10, wherein the first area is substantially totally included in the second area.

13. The device according to claim 10, wherein the means for setting in motion is a means for rotating.

14. The device according to claim 10, wherein a longitudinal section of the base at the zone of attachment of the upstanding elements measures between about 1 cm² and about 4 cm².

15. The device according to claim 10, wherein more than about 70% of the first area is included in the second area.

16. The device according to claim 10, wherein a longitudinal section of the base at the zone of attachment of the upstanding elements measures between about 2 cm² and about 3 cm².

17. An end-piece, comprising:
a base; and
elements upstanding from the base, said elements defining at least one first area of elements each having a first hardness and a second area of elements each having a second hardness greater than the first hardness,
wherein the elements are configured such that the first area is at least partly included in the second area at their zone of attachment with the base.

18. A method of massaging a portion of the body, cleansing and/or caring for the skin, and/or application of a cleansing and/or care product to the body and/or skin, said method comprising massaging said portion of the body, cleansing and/or caring for the skin, and/or application of a cleansing and/or care product to the body and/or skin with a cosmetic device comprising:
an end-piece comprising a base and elements upstanding from the base, said elements defining at least one first area of elements having a first hardness and a second area of elements having a second hardness greater than the first hardness;
a body configured to receive the end-piece; and
a means for setting the end-piece in motion relative to the body,
wherein the elements are configured such that the first area is at least partly included in the second area at their zone of attachment with the base.

19. A kit comprising a cosmetic device, the cosmetic device comprising:
an end-piece comprising a base and elements upstanding from the base, said elements defining at least one first area of elements having a first hardness and a second area of elements having a second hardness greater than the first hardness;
a body configured to receive the end-piece; and
a means for setting the end-piece in motion relative to the body,
wherein the elements are configured such that the first area is at least partly included in the second area at their zone of attachment with the base.

20. An assembly, comprising:
a cosmetic receptacle comprising a through-hole in which a base included in a device is removably housed, the device comprising:
an end-piece comprising the base and elements upstanding from the base, said elements defining at least one first area of elements having a first hardness and a second area of elements having a second hardness greater than the first hardness;
a body configured to receive the end-piece; and
a means for setting the end-piece in motion relative to the body,
wherein the elements are configured such that the first area is at least partly included in the second area at their zone of attachment with the base.
